(19) United States
(12) Patent Application Publication
(10) Pub. No.: US 2003/0112428 A1
(43) Pub. Date: Jun. 19, 2003

(54) Method and apparatus for surface inspection

(75) Inventors: Takeo Oomori, Tokyo (JP); Koichiro Komatsu, Tokyo (JP); Noriyuki Koide, Tokyo (JP)

Correspondence Address: Nelson H. Shapiro, Miles & Stockbridge P.C., Suite 500, 1751 Pinnacle Drive, McLean, VA, 22102-3833, US

(73) Assignee: Nikon Corporation

(21) Appl. No.: 10/304,787

(22) Filed: Nov. 27, 2002

Related U.S. Application Data
(63) Continuation of application No. 09/578,711, filed on May 26, 2000, now abandoned.

(30) Foreign Application Priority Data
Jun. 1, 1999 (JP) 11-154057
Feb. 25, 2000 (JP) 2000-048659

(51) Int. Cl. G01N 21/88; G01N 21/00

(52) U.S. Cl. 356/237.3

(57) ABSTRACT

The present invention has one object to provide a method and an apparatus for surface inspection capable of excellently inspecting a substrate on which repeated pattern with finer pitch is formed. In order to carry out above object, the present invention provides a surface inspection apparatus comprising; a light source unit which provides light flux; an illumination optical system which leads the light flux to a test substrate, having either one of a reflection mirror or a positive lens for illumination; a light receiving optical system which receives a diffracted light from the test substrate, having either one of a reflection mirror or a positive lens for light receiving; and a processing unit which detects surface condition of the test substrate based on output from a light receiving unit consisting of the light receiving optical system and an imaging device; wherein the light source unit provides ultraviolet light having a wavelength shorter than 400 nm.

This application claims the benefit of Japanese Patent application Nos. 11-154057 and 2000-048659 which are hereby incorporated by reference.

### BACKGROUND OF THE INVENTION

1. Field of the Invention

The present invention relates to technology for performing inspection of scratches, irregularities in the thickness of films, dust, or the like formed on liquid crystal substrates or wafers for ICs having predetermined circuit patterns thereon.

2. Related Background Art

Surface inspection of scratches, irregularities in the thickness of films, dust, or the like formed on liquid crystal substrates or wafers for ICs is usually performed such that an object is illuminated with various illumination light flux at various angles, and an examiner visually inspects a light from the object in person while rotating and rocking the object. In response to current trend in quantitative analysis of defect, work-saving inspection and automated surface inspection, various apparatuses have been proposed. For example, an image of a substrate is input by using diffracted light produced from repeated pattern on the substrate, performed image processing, so that surface inspection is to be carried out.

In ordinary visual inspection of a substrate performed by an examiner, the substrate is illuminated by white light, and quality of the substrate is checked by a change in hue of the reflected light. In this case, diffracted light is produced from a portion where repeated patterns are formed on the substrate, and the examiner is to inspect spectrum of the diffracted light. Since an exposure area (shot area) where defects such as defocus or the like exist differs in hue or intensity of the diffracted light from normal shot area surrounding that, defects can be judged by visual inspection.

When the diffracted light is produced from repeated patterns, the following conditional equation is satisfied;

sin θd−sin θi=mλ/p (1)

where reference symbol θd denotes the diffracted angle to the substrate, θi denotes the incident angle, m denotes order of diffraction, λ denotes the wavelength of the illuminated light, and p denotes pattern pitch of the surface of the substrate. As is apparent from above equation, when diffracted light from finer pitch pattern object is to be obtained under same angular relation, it is understood that order of diffraction or wavelength of the illuminated light should be smaller.

When visible light is used for the light source, the smallest value of λ is about h-line (405 nm), that is, about 400 nm is lower limit. Since 1 is the smallest absolute value of order of diffraction except 0 order, which is regular reflection, it may happen that surface inspection cannot be performed because diffracted light is not produced when pattern pitch is smaller than a certain value.

By the way, automated inspection apparatus also has aforementioned problem unless visible light is used for the light source because difference in intensity of diffracted light between defect portion and normal portion is used for the inspection as same as visible inspection.

### SUMMARY OF THE INVENTION

The present invention is made in view of the aforementioned problems and has one object to provide a method and an apparatus for surface inspection capable of excellently inspecting a substrate on which repeated pattern with finer pitch is formed.

In order to carry out above object, the present invention provides a surface inspection apparatus comprising; a light source unit which provides light flux; an illumination optical system which leads the light flux to a test substrate, having either one of a reflection mirror or a positive (convex) lens for illumination; a light receiving optical system which receives a diffracted light from the test substrate, having either one of a reflection mirror or a positive (convex) lens for light receiving; and a processing unit which detects surface condition of the test substrate based on output from a light receiving unit consisting of the light receiving optical system and an imaging device; wherein the light source unit provides ultraviolet light having a wavelength shorter than 400 nm.

According to one aspect of the present invention, a surface inspection apparatus may arrange one reflection mirror for common use as the reflection mirror for illumination and that for light receiving, or one positive (convex) lens for common use as the positive (convex) lens for illumination and that for light receiving.

Further, a plurality of combinations consisting of the light source unit and the illumination optical system, or a plurality of the light receiving units may be arranged in a surface inspection apparatus according to the present invention.

Further, in one preferred embodiment of the present invention, it is preferable to include a dull deposit removal unit which removes dull deposit on at least one of the illumination optical system and the light receiving unit produced by the ultraviolet light.

Further, in one preferred embodiment of the present invention, it is preferable to include a chamber which seals at least in the vicinity of the light source unit.

Furthermore, the present invention provides a surface inspection method comprising steps of: an illuminating step for illuminating a test substrate with a light having shorter wavelength than 400 nm; a light receiving step for receiving a light from the test substrate; and a processing step for performing photoelectric conversion of the received light in the light receiving step, and detecting surface condition of the test substrate based on information output by the photoelectric conversion.

### BRIEF DESCRIPTION OF THE DRAWINGS

FIG. 1 is a view schematically showing the configuration of a surface inspection apparatus according to a first embodiment of the present invention.

FIG. 2 is a view schematically showing the configuration of a surface inspection apparatus according to a second embodiment of the present invention.

FIG. 3 is a view schematically showing the configuration of a surface inspection apparatus according to a third embodiment of the present invention.

FIG. 4 is a view schematically showing the configuration of a surface inspection apparatus according to a fourth embodiment of the present invention.

FIG. 5 is a view schematically showing the configuration of a surface inspection apparatus according to a fifth embodiment of the present invention.

FIG. 6 is a view schematically showing the configuration of a surface inspection apparatus according to a sixth embodiment of the present invention.

FIG. 7 is a view schematically showing the configuration of a surface inspection apparatus according to a seventh embodiment of the present invention.

FIG. 8 is a view schematically showing the configuration of a surface inspection apparatus according to an eighth embodiment of the present invention.

FIG. 9 is a view schematically showing the configuration of a surface inspection apparatus according to a ninth embodiment of the present invention.

FIG. 10 is a view schematically showing the configuration of a surface inspection apparatus according to a tenth embodiment of the present invention.

FIG. 11 is a view schematically showing a first variation of the tenth embodiment.

FIG. 12 is a view schematically showing a second variation of the tenth embodiment.

FIG. 13 is a view schematically explaining sign of angular notation.

FIG. 14 is a view schematically showing a variation of the first embodiment.

FIG. 15 is a graph explaining a relation between a tilt angle and a pattern pitch of an object.

### DESCRIPTION OF THE PREFERRED EMBODIMENTS

Preferred embodiments of a surface inspection apparatus according to the present invention will be described below with reference to attached figures.

First Embodiment

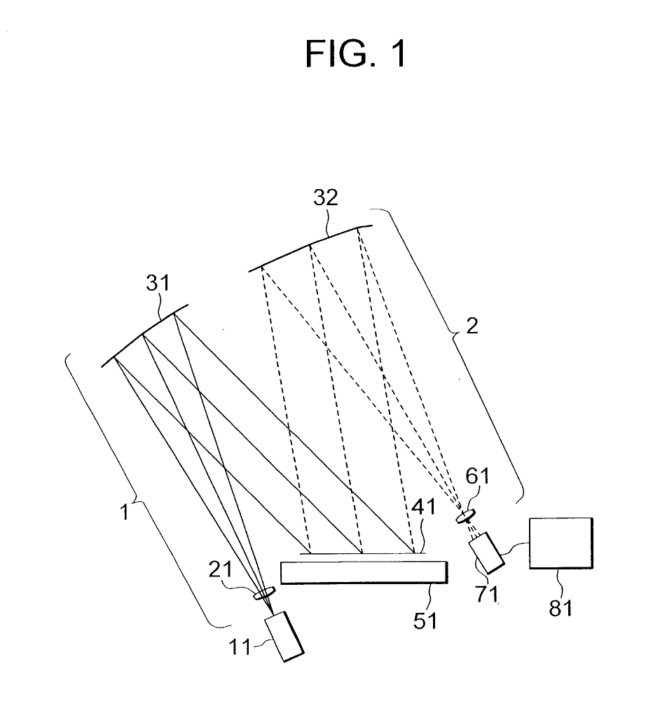

FIG. 1 is a view schematically showing the configuration of a surface inspection apparatus according to a first embodiment of the present invention. A light emitted from a light source 11 as a light source unit is incident on a spherical reflecting mirror 31 through a relay lens 21. The configuration of a light source unit is not limited to only a light source emitting a light with specific wavelength. It is possible for the configuration to include a light collection member (collector lens, ellipsoidal mirror, etc.). An illumination optical system 1 consists of the relay lens 21 and the spherical reflecting mirror 31. By the way, a positive lens can be used instead of the spherical reflecting mirror 31.

A light source such as i-line having 365 nm, J-line having 313 nm both of mercury lamp, quadruple harmonic wave of YAG laser having 266 nm, KrF excimer laser having 248 nm, ArF excimer laser having 193 nm, or the like, can be used for the light source 11. An aperture diaphragm is arranged at the exit end of the light source 11, and shields a light unnecessary for surface inspection. It is more preferable for the light source to provide a light having shorter wavelength than 365 nm.

When a mercury lamp is utilized for the light source, ultraviolet light is extracted by an interference filter, not shown in the figure, from white light emitted from the light source, and is used for illumination light. Further, it is more preferable for the light source to configure such that a plurality of interference filters having different spectral transmittance are arranged on a revolver capable of selectively inserting and removing a designated filter by rotating the revolver with a motor. When a laser is used for the light source 11, it is preferable to reduce its coherence in advance.

The light reflected from the spherical reflecting mirror 31 becomes approximately parallel, and is incident on a substrate 41 placed on a stage 51. The stage 51 can be both rotated and tilted (inclination) on a predetermined axis. A diffracted light diffracted from the substrate is reflected from a spherical reflecting mirror 32, and forms an image on a CCD imaging surface of an imaging device 71 by a camera lens 61. A light receiving optical system 2 is composed of the spherical reflecting mirror 32 and the camera lens 61, and a light receiving unit is composed of the light receiving optical system and the imaging device 71. Further, a positive lens can be used instead of the spherical reflecting mirror 32.

Since diffracted light diffracted from the substrate 41 differs in diffracted angle according to a pattern pitch, the substrate 41 can suitably be tilted by the stage 51 in order that the diffracted light is incident to the light receiving optical system 2. Either one of the illumination optical system or the light receiving optical system, or both of them may be rotated on the tilt axis instead of tilting the stage.

Furthermore, an aperture diaphragm is arranged in the camera lens 61 for shielding unnecessary light and for limiting a numerical aperture to the substrate side of the lens. To make smaller the numerical aperture by stopping down the aperture diaphragm permits to obtain wider depth of focus, and, therefore, to obtain peripheral image without blurring even while the stage is being tilted.

The camera lens 61 is not limited to a single focal length lens. It has a construction that a plurality of lenses having different focal length are interchangeable. It is desirable to change magnification by selecting lens such that the magnitude of the substrate image becomes approximately equal to that of imaging plane of the imaging device. Image processing can be performed efficiently by making the magnitude of the substrate image approximately equal to that of imaging plane of the imaging device. It is even more preferable for the camera lens 61 to be a variable focal length lens or a zoom lens because magnification can be changed without changing lens. By the way, when the surface inspection should be performed within short time, it is desirable to perform surface inspection without changing magnification.

An image processing device 81 performs image processing that pattern matching is carried out by comparing between an image of a substrate under test and a prestored image of a good substrate, or that whether there is any different characteristic or not between an image of a substrate under test and a characteristic of a good substrate studied in advance is checked. For example, when a defect of irregularity caused by defocus exists on certain portion of the substrate, the defect portion is detected and output based on difference information in brightness or in characteristic.

As for a substrate in which different pitch patterns are intermixed such as application specific IC (hereinafter called ASIC), logic circuit, and the like, surface inspection is performed in each pattern area separately. Then, each pattern area is checked whether it is good or bad, their logical addition is calculated, and final quality is judged.

Surface inspection of one pattern is usually performed under same condition. However, there is a case where difference in brightness between defect portion and good portion of obtained image is not clear because of effect of thin film interference even if defect portion really exists. Therefore, it is desirable to perform a plurality of times of inspection to one pattern by changing wavelength or changing angular condition.

The following equation is satisfied:

sin (θd−θt)− sin (θi+θt)=mλ/p (2)

where p denotes a pattern pitch of the substrate 41, λ denotes a wavelength of illumination light, m denotes an order of diffraction, θi denotes an angle between normal of the substrate when the substrate 41 is held horizontally and illumination light intersecting the substrate, θd denotes, as same as before, an angle between normal of the substrate and diffracted light intersecting the substrate, and θt denotes a tilt angle.

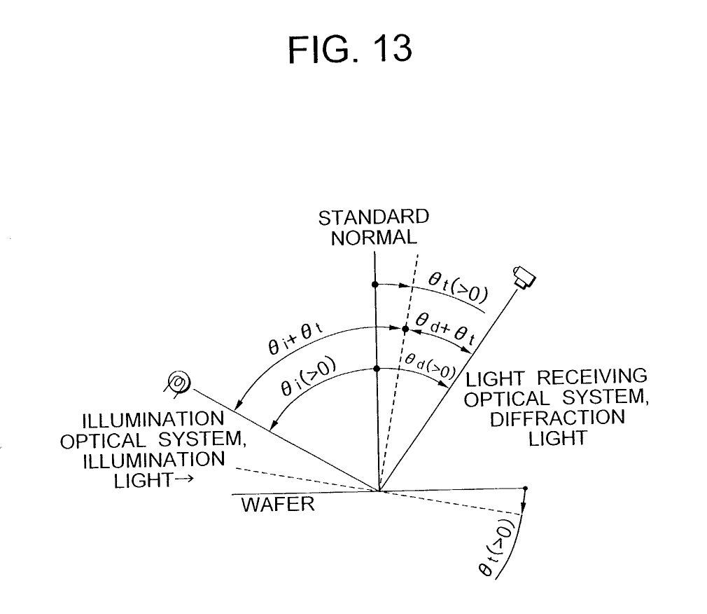

As for the sign of angular notation, referring to FIG. 13, incident angle θi of illumination light is to be positive when incident angle is measured to incident side relative to normal of the substrate, and negative when measured to opposite side. Angles for diffracted light θd and tilt θt are to be negative when angles are measured to incident side relative to normal of the substrate, and positive when measured to opposite side. As for the sign of order of diffraction m, the sign is to be negative when diffracted light is measured to incident side relative to regular reflection of incident light, and positive when measured to opposite side. Furthermore, the range of θi should be from 0° to 90°.

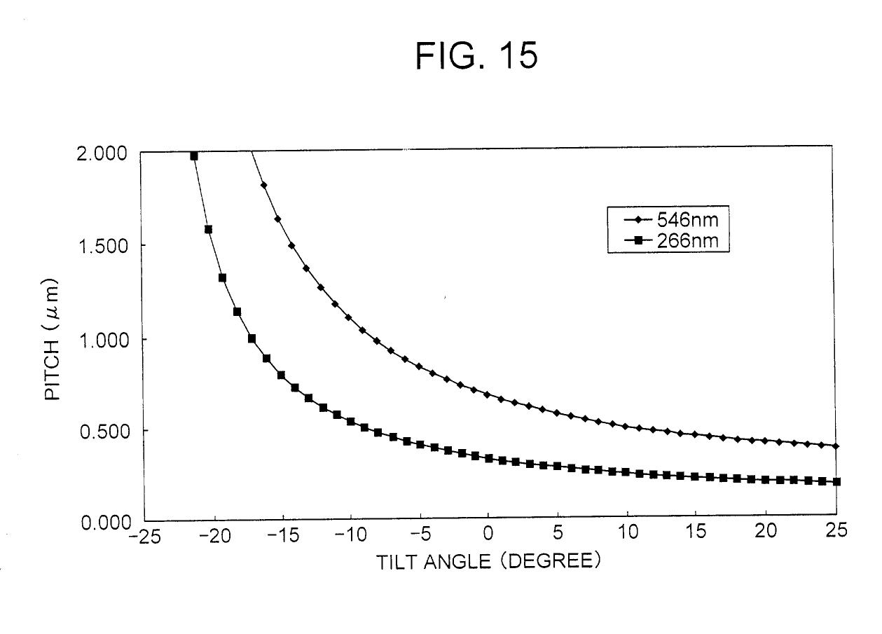

FIG. 15 is a graph explaining a relation between a tilt angle of the stage (horizontal axis) and a pattern pitch of a test object (vertical axis) when visible light with a wavelength 546 nm and ultraviolet light with a wavelength 266 nm are used, and illumination optical system and light receiving optical system are arranged such that incident angle θi and diffracted angle are +45° and −10° respectively while the stage is horizontal as a standard position. As is clear from the figure, finer pitch pattern can easily be inspected by using ultraviolet light under the same tilt angle, that is, the same angular relation.

Further, the substrate 41 is arranged to coincide with the focal plane of the spherical reflecting mirror 31. Further, in the illumination optical system 1, the light source 11 is arranged to the focal plane of the illumination optical system 1. In the light receiving optical system 2, an entrance pupil of the camera lens 61 is arranged to the focal plane of the spherical reflecting mirror 32. In this configuration, the optical system of the apparatus according to the embodiment forms a telecentric optical system. In telecentric optical systems, an appearance of the image taken by the imaging device 71 can be same over entire surface of the substrate. On the other hand, in non-telecentric optical system, the incident angle to the substrate θi+θt and the diffracted angle θd−θt in the equation (2) varies in accordance with the position on the substrate. Therefore, since the intensity of the diffracted light varies with respect to the incident angle, there is a case that images of the same defect may appear differently in accordance with the position on the substrate. The surface inspection apparatus (FIG. 1) according to the present embodiment has a telecentric optical system, so that the incident angle θi+θt and the diffracted angle θd−θt can be constant all over the substrate surface. Accordingly, positions having same defect appear same regardless of the defect position on the substrate, so that detection sensitivity becomes equal, and, as a result, the defect position can be identified more quickly and accurately.

Furthermore, the apparatus can be made compact by applying catoptric telecentric optical system using a spherical reflecting mirror in stead of applying a dioptric telecentric optical system in order to avoid the apparatus to become large. Further, it is preferable that the incident angle of the reflected light to the spherical reflecting mirror is to be small in order to make astigmatism small because the optical system is a decentered optical system. In the present embodiment, the incident angle of the reflected light to the spherical reflecting mirror is about 10°.

Second Embodiment

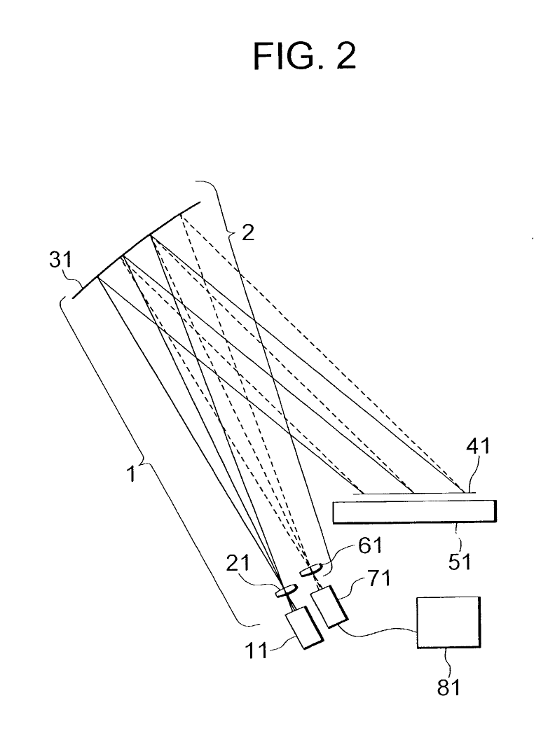

FIG. 2 is a view schematically showing the configuration of a surface inspection apparatus according to a second embodiment of the present invention. By the way, in all embodiments including the present embodiment described below, the same portion as the first embodiment described above is denoted as same symbol used in the first embodiment, and duplicated explanation will be abbreviated.

The present embodiment is amodification of the first embodiment. Since absolute value of the incident angle to the test substrate 41 and absolute value of the diffracted light are arranged to be slightly different, spherical reflecting mirrors composing the illumination optical system 1 and the light receiving optical system 2 in the above described first embodiment are replaced by only one spherical reflecting mirror 31 for common use. Using this configuration, the apparatus can be made smaller than that of the first embodiment, and makes it possible to perform surface inspection of finer pitch pattern.

Third Embodiment

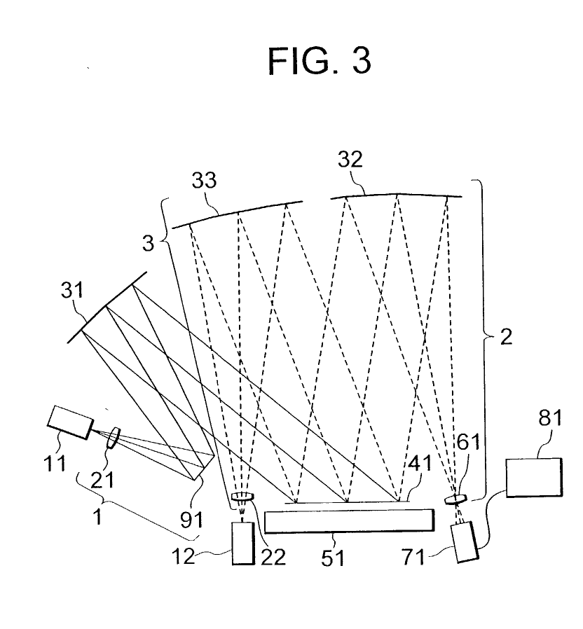

FIG. 3 is a view schematically showing the configuration of a surface inspection apparatus according to a third embodiment of the present invention. The configuration has a light source unit 12 and an illumination optical system 3 added to the apparatus according to the first embodiment. The illumination optical system 3 is composed of a relay lens 22 and a spherical reflecting mirror 33. Since an angular condition of illumination from the illumination optical system 1 is different from that from the illumination optical system 3, two kinds of pitch patterns can be inspected at a same time, which is effective for saving processing time. It is particularly effective to inspect logic circuit, ASIC, or the like having different pitch patterns in it. Further, it is possible to inspect one pattern under two different conditions at a time by using different wavelength between the light source 11 and the light source 12.

Fourth Embodiment

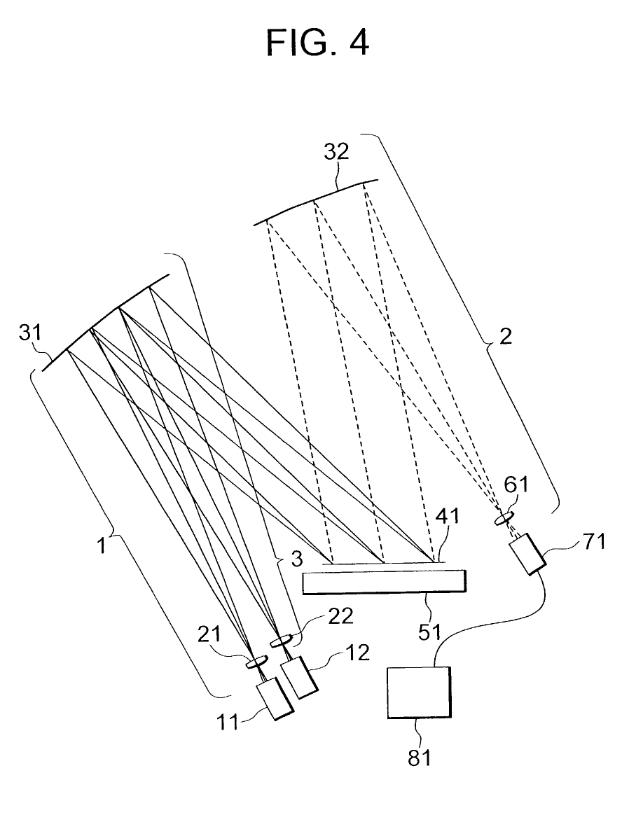

FIG. 4 is a view schematically showing the configuration of a surface inspection apparatus according to a fourth embodiment of the present invention. The present embodiment is a modification of the third embodiment. Spherical reflecting mirrors composing the illumination optical system 1 and the illumination optical system 3 are replaced by only one spherical reflecting mirror 31 for common use. In other words, it has the same construction that a new light source is added in the vicinity of the light source 11 of the apparatus according to the second embodiment. If wavelengths for two light sources are the same, two kinds of pitch patterns can be inspected at a same time. Further, it is possible to inspect one pattern under two different conditions at a time by using different wavelength between two light sources. As a result, it is possible for the apparatus to be made compact.

Fifth Embodiment

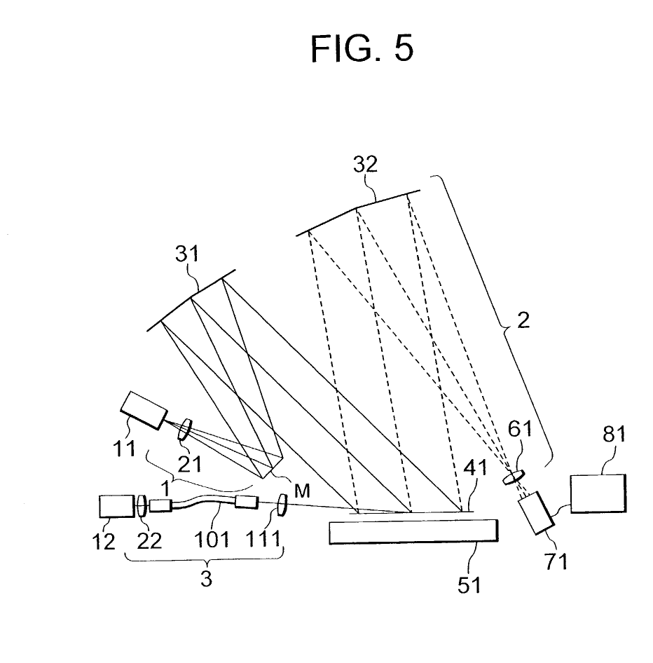

FIG. 5 is a view schematically showing the configuration of a surface inspection apparatus according to a fifth embodiment of the present invention. The fifth embodiment has a construction that a line typed light guide fiber 101 and a cylindrical lens 111 are used instead of the illumination optical system 1 or the illumination optical system 3 according to the third embodiment. Further, a light emitted from the light source 11 is folded by a reflecting mirror M. With this construction, an illumination loss can be relieved even in larger incident angle.

Sixth Embodiment

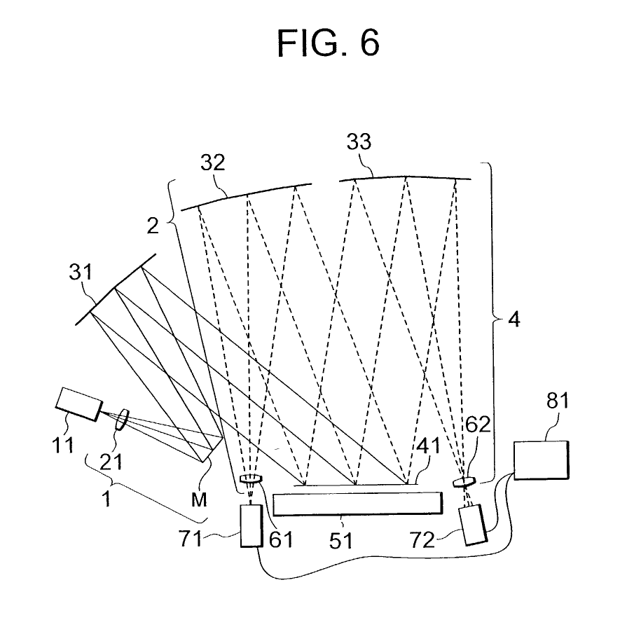

FIG. 6 is a view schematically showing the configuration of a surface inspection apparatus according to a sixth embodiment of the present invention. The sixth embodiment has a construction that a pair of light receiving optical system 4 is added to the first embodiment. The light receiving optical system 4 is composed of a spherical reflecting mirror 33 and a camera lens 62, and an image formed by the light receiving optical system 4 is detected by an imaging device 72. Further, a light emitted from the light source 11 is folded by a reflecting mirror M. Since angular condition of these two light sources is different with each other as same as the third and fourth embodiment, two kinds of pitch patterns can be inspected at a same time, which is effective for saving processing time. Further, it is possible to inspect one pattern (test object) under two different conditions at a time by using a light source having a plurality of spectrum lines (wavelength) such as mercury lamp, etc. It is also same as the third and fourth embodiment that this embodiment is particularly effective to inspect logic circuit, ASIC, or the like.

Seventh Embodiment

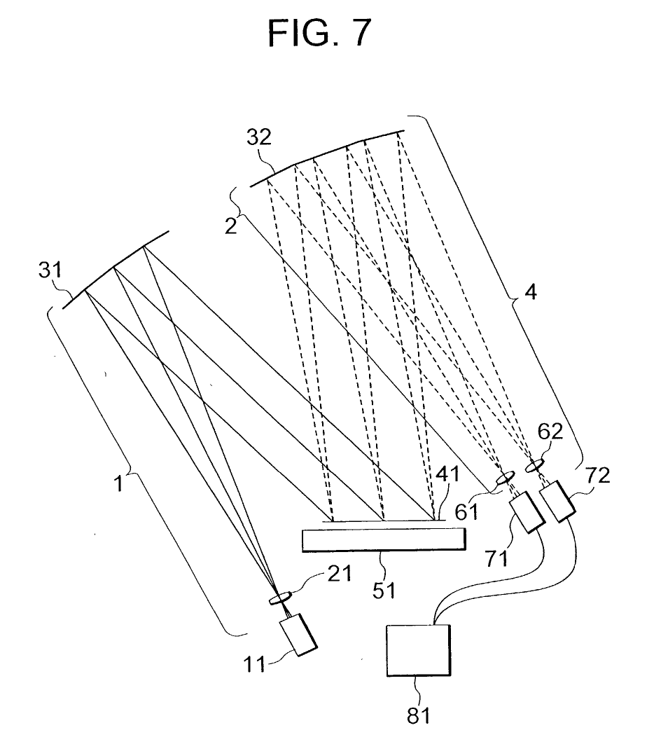

FIG. 7 is a view schematically showing the configuration of a surface inspection apparatus according to a seventh embodiment of the present invention. The present embodiment is a modification of the sixth embodiment. Spherical reflecting mirrors composing the light receiving optical system 2 and the light receiving optical system 4 are replaced by only one spherical reflecting mirror 32 for common use. In other words, it has the same construction that a new camera lens 62 and imaging device 72 are added in the vicinity of the light receiving optical system according to the first embodiment. Since angular condition of these two light receiving optical systems is different with each other, two kinds of pitch patterns can be inspected at a same time. Further, it is possible to inspect one pattern (test object) under two different conditions at a time by using a light source having a plurality of spectrum lines (wavelength) such as mercury lamp, etc. As a result, it is possible for the apparatus to be made compact.

Eighth Embodiment

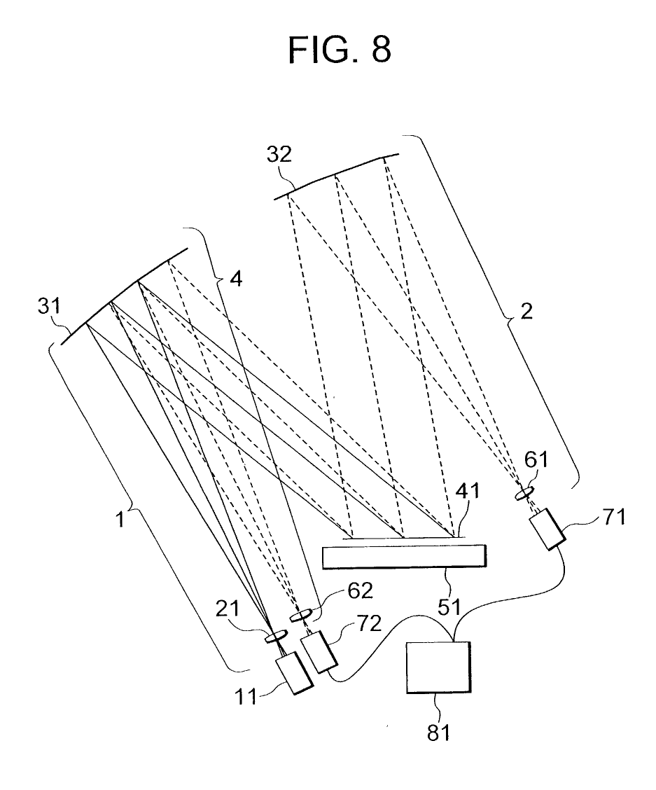

FIG. 8 is a view schematically showing the configuration of a surface inspection apparatus according to an eighth embodiment of the present invention. The present embodiment is a modification of the sixth embodiment. Spherical reflecting mirrors composing the illumination optical system 1 and the light receiving optical system 4 are replaced by only one spherical reflecting mirror 31 for common use. In other words, it has the same construction that a new camera lens 62 and imaging device 72 are added in the vicinity of the light source according to the first embodiment. Since angular condition of these two light receiving optical systems is different with each other, two kinds of pitch patterns can be inspected at a same time. Further, it is possible to inspect one pattern (test object) under two different conditions at a time by using a light source having a plurality of spectrum lines (wavelength) such as mercury lamp, etc. As a result, it is possible for the apparatus to be made compact.

Ninth Embodiment

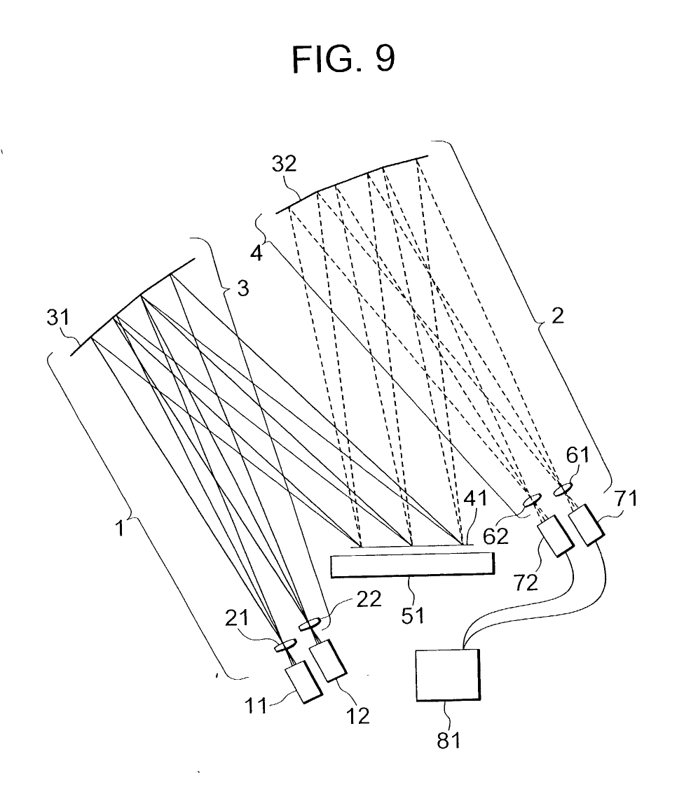

FIG. 9 is a view schematically showing the configuration of a surface inspection apparatus according to an ninth embodiment of the present invention. The ninth embodiment has two pairs of illumination optical systems 1 and 3, and two pairs of light receiving optical systems 2 and 4. A spherical reflecting mirror 31 is used for two pairs of illumination optical systems in common, and a spherical reflecting mirror 32 is used for two pairs of light receiving optical systems in common. Light sources 11 and 12 of illumination optical systems differ in used wavelength of each light source. Since it is difficult to correct chromatic aberration of a camera lens in certain wavelength region shorter than 300 nm, surface inspection is performed by using two pairs of light receiving optical systems, each of which is used in different wavelength.

Tenth Embodiment

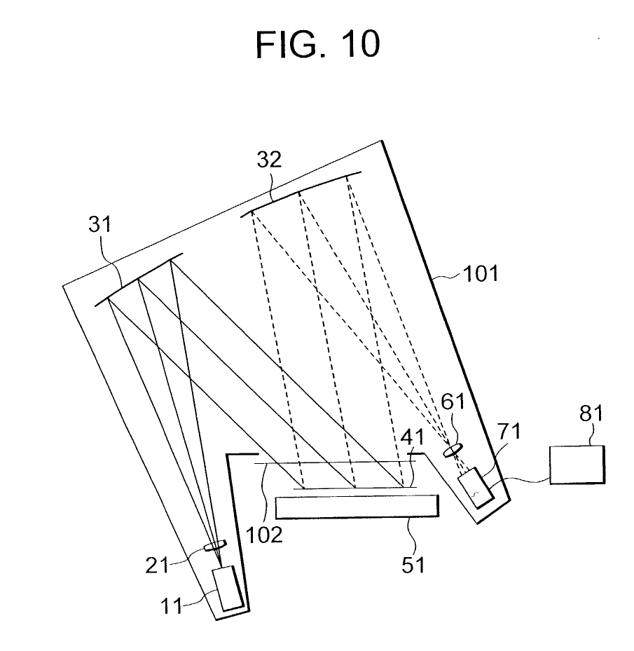

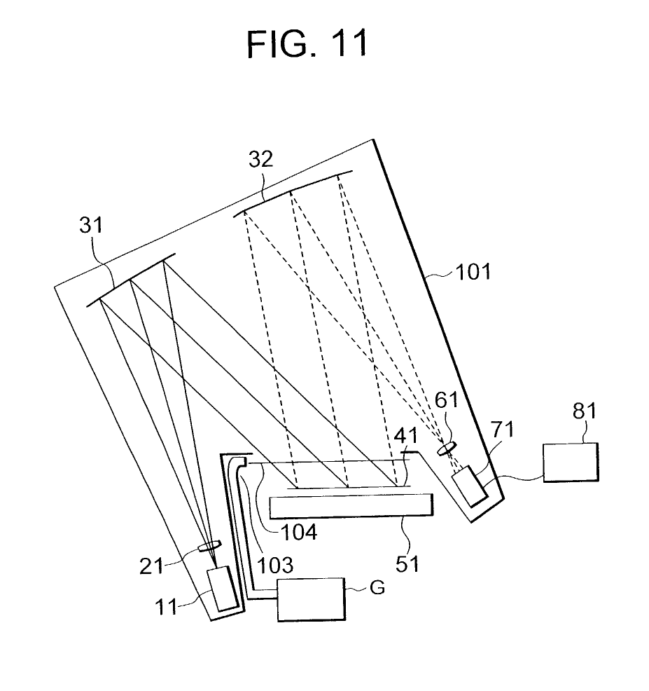

FIGS. 10 and 11 are views schematically showing the configuration of a surface inspection apparatus according to a tenth embodiment of the present invention. Basic construction is same as the first embodiment, and the same portion as the first embodiment is denoted as same symbol used in the first embodiment, and duplicated explanation is abbreviated. When a ultraviolet light, particularly shorter wavelength than i-line, is used for the light source, a photochemical reaction is induced by the ultraviolet light and NH₄⁺ or SOₓ included in air, and produces, for example, (NH₄)₂SO₄. Then, it sticks to the surface of optical elements, so that dull deposit is produced on optical elements. As a result, it causes reduction of reflectance in catoptric optical elements (mirror, etc.), and reduction of transmittance in dioptric optical elements (lens, etc.). Further, since a light source such as ArF excimer laser has emitting spectrum coincide with absorption spectrum of oxygen, it happens reduction of transmittance caused by absorption of oxygen. Furthermore, produced ozone causes further reduction of reflectance in catoptric optical elements or transmittance in dioptric optical elements, and environmental contamination produced inside apparatus caused by reaction with surface of optical elements. The present embodiment is made in view of those problems and has a chamber 101 surrounding whole optical system, arranging a windowpane (windowglass) 102 on a portion where light is in and out. Production of (NH₄)₂SO₄ and environmental contamination produced inside apparatus caused by production of ozone can be prevented by filling inert gas such as nitrogen, etc., in the chamber 101. Regarding gas for filling the chamber 101 except nitrogen, inert gas such as helium (He), argon (Ar), or the like can be used. Further, the atmosphere inside the chamber 101 can be made vacuum instead of filling inert gas. Furthermore, aforementioned dull deposit may produce on the windowpane 102 because air exists between the windowpane 102 and the substrate 41. Accordingly, it is desirable to replace the windowpane 102 periodically. Since not all optical parts are necessary to be replaced, it is rather economical. Further, in order to reduce production of dull deposition, it is desirable to make the distance between the substrate 41 and the windowpane 102 as small as possible.

FIG. 11 is a view schematically showing a first variation of the tenth embodiment and an air curtain 104 using inert gas is used instead of the windowpane 102. Inert gas supplied from an inert gas supply unit G blows out vigorously to form the air curtain 104. The air curtain 104 made of inert gas prevents air around the substrate 41 to go into the chamber 101. Further, it is possible to arrange the air curtain 104 besides the windowpane 102. In this case, it is not necessary to replace the windowpane 102. Further, it is possible that the whole apparatus, not only optical system, is filled with inert gas. In this case, since it may happen that contaminated air goes in the apparatus from an exit of the substrate (not shown) while changing the substrate, it is desirable to form an air curtain using inert gas near the exit of the substrate in order to prevent the open air from going in the apparatus.

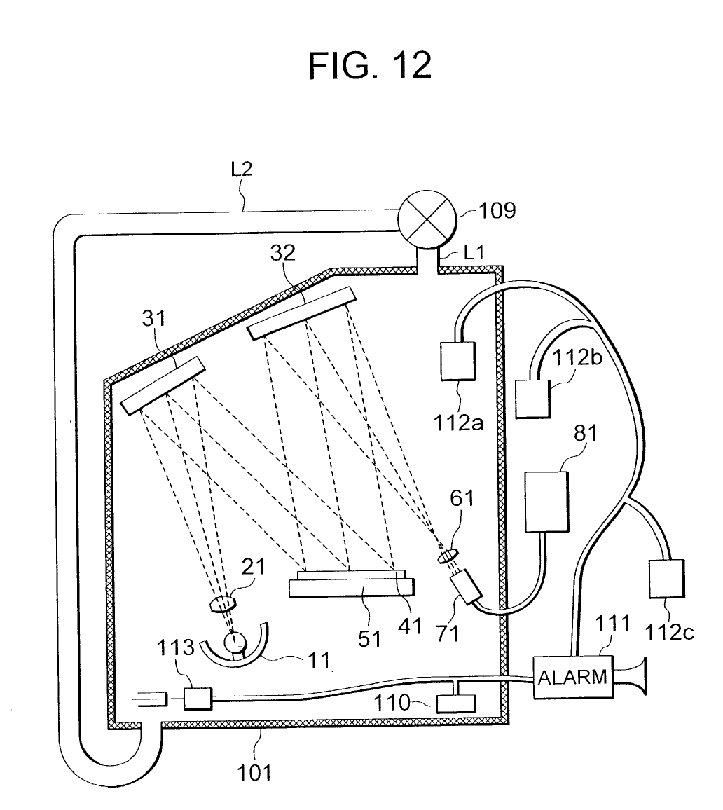

FIG. 12 is a view schematically showing a second variation of the tenth embodiment. This is a case where the substrate and the whole apparatus are stored in the chamber and nitrogen is used for inert gas. The chamber 101 is equipped with a nitrogen-supplying device 109, and the air inside the chamber 101 is replaced with nitrogen. For example, before inspection, nitrogen is filled until predetermined density, and the nitrogen-supplying device 109 is cut off from the chamber 101 while inspecting. On the contrary, nitrogen may be continuously supplied to the chamber 101 while inspecting.

A pressure gauge 110 and an oxygen densitometer 112a are installed inside the chamber 101. An oxygen densitometer 112b and an alarm 111 are attached outside the chamber 101. Workspace outside the chamber 101 is usually a clean room.

The pressure gauge 110 measures pressure inside the chamber 101. The oxygen densitometer 112a measures oxygen density inside the chamber 101. The oxygen densitometer 112b measures oxygen density of workspace outside the chamber 101. The pressure gauge 110, the oxygen densitometer 112a and the oxygen densitometer 112b are connected to the alarm 111 respectively.

Further, if the chamber 101 is pressurized more than 1030 hPa (hecto-pascal), nitrogen leakage from the chamber 101 can easily be detected by reduction of pressure inside the chamber 101. The pressure gauge 110 detects the variation in pressure, and output a warning signal to the alarm 111. The alarm 111 gives out a warning sound for worker to be notified the leakage of nitrogen.

On the other hand, when oxygen density detected by the oxygen densitometer 112b arranged outside the chamber 101 is less than 18.5%, the alarm 111 gives out a warning sound for worker to be notified the oxygen density in the workspace has become low. The oxygen densitometer 112a measures oxygen density inside the chamber 101, and makes it possible to detect an inflow of oxygen into the chamber 101, or completion of filling the chamber 101 with nitrogen. Therefore, a display (not shown) in the workspace is connected to the oxygen densitometer 112a, and successively displays the oxygen density in the chamber 101.

The oxygen density in the workspace may vary locally by airflow in the workspace. Accordingly, in the workspace outside the chamber 101, it is desirable to arrange an oxygen densitometer 112c, which is connected to the alarm 111, at other point where the oxygen densitometer 112b exists. In this case, the number of the oxygen densitometer 112c and the point to be arranged them are to be suitably decided in accordance with obstacles possibly varying airflow in the workspace, that is shape and dimension of the workspace, and arrangement of other equipment and air duct.

The chamber 101 is equipped with a nitrogen-supplying device 109, and the inside of the chamber 101 is replaced with nitrogen. The nitrogen-supplying device 109 supplies nitrogen gas to the chamber 101 through a gas supply duct L1, and collects nitrogen gas from the chamber 101 through a gas return duct L2. In other words, it circulates nitrogen gas within the chamber 101. A airflow-meter 113 and an oxygen densitometer 112a are installed inside the chamber 101. An oxygen densitometer 112b and an alarm 111 are attached outside the chamber 101.

The airflow-meter 113 measures an airflow inside the chamber 101. The oxygen densitometer 112a measures oxygendensity inside the chamber 101. The oxygen densitometer 112b measures oxygen density of workspace outside the chamber 101. The airflow-meter 113, the oxygen densitometer 112a and the oxygen densitometer 112b are connected to the alarm 111 respectively.

The airflow-meter 113 measures an airflow inside the chamber 101 as described above. For example, if a hole is bored through the chamber 101, nitrogen leaks through the hole, and the leakage varies the airflow in the chamber 101, then, the airflow-meter 113 measures the variation in the airflow. When the airflow-meter 113 measures the variation in the airflow, the alarm 111 is activated giving out-warning sound. The oxygen densitometer 112a arranged inside the chamber 101 and the oxygen densitometer 112b arranged outside the chamber 101 are connected to the alarm 111.

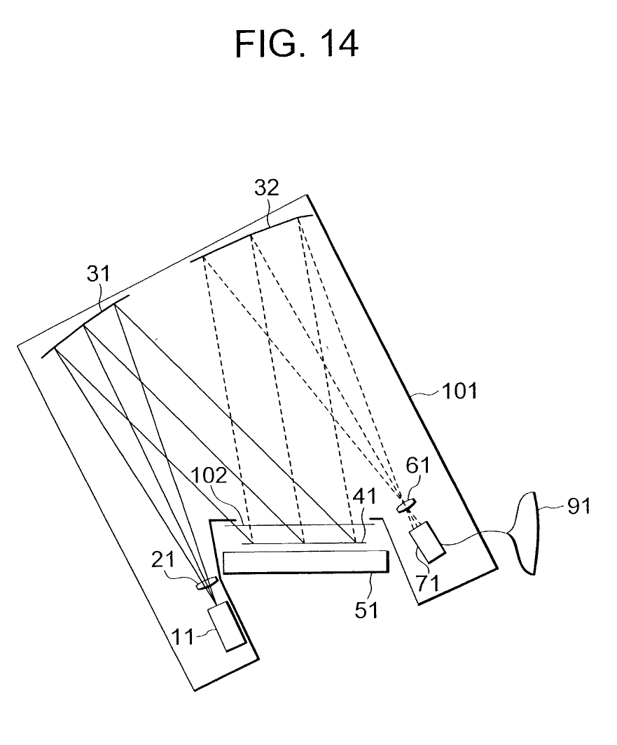

Furthermore, in aforementioned first through tenth embodiment, automated surface inspection apparatuses using the image processing device 81 are described. Instead of an automated surface inspection apparatuses using the image processing device 81, it may be a visual inspection apparatus with which an inspector visually judges quality of the substrate using a monitor displaying an image of the substrate. A construction example of a visual inspection apparatus is shown in FIG. 14. Figure shows an example that the image processing device 81 of the surface inspection apparatus according to the first embodiment is replaced with a TV monitor 91. A substrate image formed by a diffracted light is displayed on the monitor, and an inspector visually observes the substrate image, and, as a result, the substrate is judged. An optical system from a light source to a CCD imaging device is enclosed in a chamber 101. This has a purpose to prevent ultraviolet light leaked from the apparatus exerting a bad influence on a human body, and, also, a purpose to prevent dull deposit producing on optical elements by filling inside the chamber 101 with chemically clean air or inert gas such as nitrogen or the like, as described above.

In aforementioned surface inspection apparatuses according to the second through ninth embodiment, it is needless to say that production of dull deposit on optical elements can be reduced by enclosing optical systems in a chamber 101 and filling it with inert gas.

Further, in each embodiment described above, light sources having two kinds of wavelength are used because there may be such case that finer pitch pattern and coarser one coexist in one substrate such as a logic circuit, ASIC, etc. In other words, one of the two kinds of wavelength may be ultraviolet light for inspecting finer pitch pattern and the other one may be visible light for inspecting coarser pitch pattern. In this case, since it is difficult to correct chromatic aberration (achromatizing) of the light receiving optical system in both ultraviolet and visible light, it is desirable to arrange a light receiving optical system exclusive for visible light and that for ultraviolet light respectively.

Accordingly, whether a fine circuit pattern formed on a test substrate is good or not (judgement) is performed by inspecting a test object using the surface inspection apparatus according to the each embodiment described above. As a result, only an accepted substrate is transferred to the next process for completion of device or the like, and a rejected substrate is transferred to reproduction process, regeneration process, or waste line.

Therefore, by performing the inspection process using the surface inspection apparatus according to above-described each embodiment, a fine circuit pattern on a test substrate (photosensitive substrate such as wafer or the like) can be securely inspected with precision, so that excellent semiconductor (semiconductor device, liquid crystal display, thin film magnetic head, or the like) can be fabricated.

Furthermore, the present invention is not limited to the disclosure described above, and is able to include following description. That is, for example, the present invention can provide a method for fabricating semiconductor device including an inspection process for inspecting a photosensitive substrate wherein the inspection process comprising steps of: a illuminating step for illuminating the substrate with a light having a wavelength shorter than 400 nm; a light receiving step for receiving a light from the substrate; and a processing step for performing a photoelectric conversion of the received light in the light receiving step, and detecting surface condition of the substrate. In this case, it is preferable that an illumination optical system is used for the illuminating step, and a light receiving optical system is used for the light receiving step. It is more preferable that at least one of the illumination step and the light receiving step includes a dull deposit preventing step for preventing production of dull deposit.

As described above, the present invention makes it possible to inspect a fine pitch pattern by using ultraviolet light for a light source. Furthermore, the present invention makes it possible to prevent dull deposition by enclosing optical systems in a chamber providing inert gas inside it.

What we claim is:

1. A surface inspection apparatus comprising:
a light source unit which provides a light flux;
an illumination optical system which leads said light flux to a test substrate, having either one of a reflection mirror or a positive lens for illumination;
a light receiving optical system which receives a diffracted light from said test substrate, having either one of a reflection mirror or a positive lens for light receiving; and
a processing unit which detects a surface condition of said test substrate based on an output from a light receiving unit consisting of said light receiving optical system and an imaging device;
wherein said light source unit provides a ultraviolet light having a wavelength shorter than 400 nm.

2. A surface inspection apparatus according to claim 1, wherein a reflection mirror is arranged for common use as said reflection mirror for illumination and said reflection mirror for light receiving, or a positive lens is arranged for common use as said positive lens for illumination and said positive lens for light receiving.

3. A surface inspection apparatus according to claim 1, and further comprising a plurality of combinations consisting of said light source unit and said illumination optical system.

4. A surface inspection apparatus according to claim 1, and further comprising a plurality of said light receiving units.

5. A surface inspection apparatus according to claim 3, wherein said reflection mirror for illumination or said positive lens for illumination is used in common in said plurality of illumination optical systems.

6. A surface inspection apparatus according to claim 4, wherein said reflection mirror for light receiving or said positive lens for light receiving is used in common in said plurality of light receiving optical systems.

7. A surface inspection apparatus according to claim 3, wherein said reflection mirror for light receiving is used in common with at least one of said plurality of reflection mirrors for illumination, or said positive lens for light receiving is used in common with at least one of said plurality of positive lenses for illumination.

8. A surface inspection apparatus according to claim 4, wherein said reflection mirror for illumination is used in common with at least one of said plurality of reflection mirrors for light receiving, or said positive lens for illumination is used in common with at least one of said plurality of said positive lenses for light receiving.

9. A surface inspection apparatus according to claim 1, and further comprising:
a dull deposit removal unit which removes dull deposit on at least one of said illumination optical system and said light receiving unit produced by said ultraviolet light.

10. A surface inspection apparatus according to claim 2, and further comprising:
a dull deposit removal unit which removes dull deposit on at least one of said illumination optical system and said light receiving unit produced by said ultraviolet light.

11. A surface inspection apparatus according to claim 3, and further comprising:
a dull deposit removal unit which removes dull deposit on at least one of said illumination optical system and said light receiving unit produced by said ultraviolet light.

12. A surface inspection apparatus according to claim 4, and further comprising:
a dull deposit removal unit which removes dull deposit on at least one of said illumination optical system and said light receiving unit produced by said ultraviolet light.

13. A surface inspection apparatus according to claim 1, and further comprising:
a chamber which seals at least in the vicinity of said light source unit.

14. A surface inspection apparatus according to claim 2, and further comprising:
a chamber which seals at least in the vicinity of said light source unit.

15. A surface inspection apparatus according to claim 3, and further comprising:
a chamber which seals at least in the vicinity of said light source unit.

16. A surface inspection apparatus according to claim 4, and further comprising:
a chamber which seals at least in the vicinity of said light source unit.

17. A surface inspection apparatus according to claim 13, and further comprising:
an oxygen densitometer arranged outside said chamber; and
an alarm unit which gives out a warning signal when oxygen density outside said chamber becomes lower than a standard value based on a measured signal output from said oxygen densitometer.

18. A surface inspection method comprising steps of:
an illuminating step for illuminating a test substrate with a light having shorter wavelength than 400 nm;
a light receiving step for receiving a light from said test substrate; and
a processing step for performing a photoelectric conversion of said received light in the light receiving step, and detecting surface condition of said test substrate based on information output by said photoelectric conversion.
